(19) United States
(12) Patent Application Publication
(10) Pub. No.: US 2023/0116567 A1
(43) Pub. Date: Apr. 13, 2023

(54) METHOD FOR ANALYZING NUCLEIC ACID DRUGS

(71) Applicant: LSI MEDIENCE CORPORATION, Tokyo (JP)

(72) Inventor: Shin-ichiro NITTA, Tokyo (JP)

(21) Appl. No.: 17/905,009

(22) PCT Filed: Feb. 24, 2021
(86) PCT No.: PCT/JP2021/006930

§ 371 Date: Aug. 25, 2022

(30) Foreign Application Priority Data
Feb. 25, 2020 (JP) 2020-029294
Jul. 17, 2020 (JP) 2020-122679

(51) Int. Cl. G01N 30/72; G01N 30/06; G01N 30/26

(52) U.S. Cl. CPC G01N 30/7233; G01N 30/06; G01N 30/26; G01N 2030/027

(57) ABSTRACT

Continuous analysis of ionic substances, such as oligonucleotide therapeutics, can be conducted over a long period of time while maintaining high sensitivity in liquid chromatography-mass spectrometry. An analysis method includes subjecting a sample containing an ionic analyte to liquid chromatography using a mobile phase containing a basic ion-pair reagent and further subjecting the analyte to mass spectrometry. An operation to prevent deterioration of the mobile phase can be conducted,

### FIELD OF THE INVENTION

The present invention relates to a method for analyzing ionic substances such as oligonucleotide therapeutics by liquid chromatography-mass spectrometry, which prevents deterioration of a mobile phase in liquid chromatography and the like. The term “analysis” as used herein includes the meaning of “measurement” to determine an amount of an analyte qualitatively, quantitatively or semi-quantitatively.

### BACKGROUND ART

In recent years, the importance of analyzing trace substances contained in biological samples has been increasing. In particular, not only analysis for biomarker proteins that undergo variation such as induction, loss or the like, depending on diseases, but also similar highly accurate analysis for ionic substances such as mononucleotides, metabolites of mononucleotides, modifiers, oligonucleotides composed of a plurality of nucleotides, saccharides, glycans and the like, has been desired. As for analysis of ionic substances contained in biological samples, an accurate method for analyzing oligonucleotide therapeutics is also required.

The oligonucleotide therapeutic is composed of oligonucleotides composed of ten to several dozen bases of (modified) oligonucleotide therapeutics linked together and acts directly on living organisms, and is a pharmaceutical manufactured through chemical synthesis. The oligonucleotide therapeutic acts directly on the living organisms to inhibit expression of specific proteins and the like and is expected to provide new treatment methods for diseases that have been difficult to treat. Moreover, several oligonucleotide therapeutics have already been approved for production and marketing.

When measuring ionic substances, for example, as an analysis method of oligonucleotides, an analysis method using liquid chromatography-mass spectrometry has been known (Patent Document 1), however, for production management of pharmaceuticals or the like, it is desirable to use a more highly precise analytical method enabling continuous analysis over a long period of time without loss of sensitivity.

### RELATED ART DOCUMENT

### Patent Document

[Patent Document 1] Japanese Translation of PCT International Application Publication No. 2012-500394

### SUMMARY OF THE INVENTION

### Technical Problem

An object of the present invention is to provide a means enabling continuous analysis of ionic substances such as oligonucleotide therapeutics (hereinafter simply referred to as oligonucleotide therapeutics or the like) over a long period of time while maintaining high sensitivity in liquid chromatography-mass spectrometry.

### Solution to Problem

The present inventors have found, as a result of diligent investigations in order to solve the problem described above, that in the case of measuring ionic substances such as oligonucleotide therapeutics with liquid chromatography-mass spectrometry, a decrease in sensitivity occurs, particularly in continuous analysis over a long period of time. Moreover, the present inventors have also found that such a decrease in sensitivity in continuous analysis is due to deterioration of a basic ion-pair reagent in a mobile phase and have further found that the deterioration of mobile phase can be prevented by preventing deterioration of the basic ion-pair reagent in the mobile phase, and thus have completed the present invention based on these findings.

Namely, the present invention is as follows:
An analysis method comprising a step of subjecting a sample containing an ionic analyte to liquid chromatography using a mobile phase containing a basic ion-pair reagent and further subjecting the analyte to mass spectrometry, wherein
   the analysis method conducts an operation to prevent deterioration of the mobile phase.
The method according to [1], wherein the operation to prevent deterioration of the mobile phase comprises bubbling of the mobile phase with an inert gas.
The method according to [2], wherein the operation to prevent deterioration of the mobile phase further comprises managing and controlling the bubbling of the mobile phase with an inert gas.
The method according to any one of [1] to [3], wherein the operation to prevent deterioration of the mobile phase comprises use of a mobile phase containing the basic ion-pair reagent in a nonaqueous solvent.
The method according to any one of [1] to [4], wherein the basic ion-pair reagent is an amine compound.
The method according to any one of [1] to [5], wherein the basic ion-pair reagent is at least one or more types selected from the group consisting of tetraethylammonium hydroxide (TEA-OH), tetrabutylammonium hydroxide (TBAOH), N,N-dimethylbutylamine (DMBA), octylamine (OA), tripropylamine (TPA), N,N-dimethylhexylamine (DMHA), diisopropylamine (DIPA), N-methyldibutylamine (MDBA), propylamine (PA), triethylamine (TEA), hexylamine (HA), tributylamine (TBA), N,N-dimethylcyclohexylamine (DMCHA), N,N-diisopropylethylamine (DIEA), tetramethylethylenediamine (TMEDA), 1,8-diazabicyclo[5.4.0]undec-7-ene (DBU), dipropylammonium acetate (DPAA), dibutylammonium acetate (DBAA), diamylammonium acetate (DAAA), and dihexylammonium acetate (DHAA).
The method according to any one of [1] to [6], wherein the ionic analyte is at least one or more types selected from the group consisting of a nucleoside containing a purine compound, a purine compound analogue, a pyrimidine compound, or a pyrimidine compound analogue; a nucleotide, a cyclic nucleotide, a nucleotide diphosphate, and a nucleotide triphosphate; a coenzyme containing a nucleoside selected from nicotinamide adenine dinucleotide phosphate (NAD, NADPH), flavin adenine dinucleotide (FAD, FADH), coenzyme A, tetrahydromethanopterin (H4MPT), S-adenosylmethionine (SAM), and 3′-phosphoadenosine-5′-phosphosulfate; metabolic intermediates thereof, as well as reduced hydrogen acceptors and modifiers thereof; an oligonucleotide, a saccharide, and a glycan.
The method according to [7], wherein the oligonucleotide is at least one or more types of oligonucleotide therapeutics selected from the group consisting of antisense, a decoy, siRNA, miRNA, a ribozyme, a CpG oligo, and an aptamer.
The method according to [7], wherein the saccharide and the glycan are each at least one or more types selected from the group consisting of a monosaccharide, a disaccharide, and an oligosaccharide.
The method according to any one of [2] to [9], wherein the inert gas is at least one or more types selected from the group consisting of a nitrogen gas, an argon gas, a neon gas, a krypton gas, a xenon gas, and a helium gas.
A method for preventing deterioration of a mobile phase of liquid chromatography, comprising a step of bubbling the mobile phase of liquid chromatography containing a basic ion-pair reagent.
A method for preventing deterioration of a mobile phase, comprising a step of preparing a mobile phase in which a basic ion-pair reagent is dissolved in a nonaqueous solvent, mixing the mobile phase with a mobile phase containing water, and using the mixture for liquid chromatography.
An analytical apparatus, comprising
   a liquid chromatography apparatus separating a sample containing an ionic analyte by using a mobile phase containing a basic ion-pair reagent,
   a mass spectrometer for analyzing the analyte, and
   a deterioration prevention apparatus of the mobile phase.
The analytical apparatus according to [13], wherein the deterioration prevention apparatus of the mobile phase is a gas bubbling apparatus of the mobile phase.
The analytical apparatus according to [14], wherein the deterioration prevention apparatus of the mobile phase further includes a means and a software for managing and controlling bubbling of the mobile phase.
The analytical apparatus according to [13], wherein the deterioration prevention apparatus of the mobile phase is an apparatus for mixing a mobile phase containing a basic ion-pair reagent in a nonaqueous solvent with a mobile phase containing water.

### Effects of the Invention

According to the present invention, it is possible to continuously analyze ionic substances, such as oligonucleotide therapeutics, by liquid chromatography-mass spectrometry over a long period of time while maintaining high sensitivity.

### BRIEF DESCRIPTION OF THE DRAWINGS

FIG. 1 is a view illustrating transition of peak area values of mipomersen-MOE and mipomersen-S oligo (160 continuous analyses) when nitrogen bubbling was not carried out.

FIG. 2 is a view illustrating transition of peak area ratios of mipomersen-MOE/mipomersen-S oligo (160 continuous analyses) when nitrogen bubbling was not carried out.

FIG. 3 is a view illustrating transition of peak area values of mipomersen-MOE and mipomersen-S oligo (160 continuous analyses) when nitrogen bubbling was carried out.

FIG. 4 is a view illustrating transition of peak area ratios of mipomersen-MOE/mipomersen-S oligo (160 continuous analyses) when nitrogen bubbling was carried out.

FIG. 5 is a view illustrating transition of peak area values of mipomersen-MOE (240 continuous analyses) when nitrogen bubbling was not carried out.

FIG. 6 is a view illustrating transition of peak area values of mipomersen-OMe (240 continuous analyses) when nitrogen bubbling was not carried out.

FIG. 7 is a view illustrating transition of peak area values of mipomersen-LNA (240 continuous analyses) when nitrogen bubbling was not carried out.

FIG. 8 is a view illustrating transition of peak area values of mipomersen-MOE (240 continuous analyses) when nitrogen bubbling was carried out.

FIG. 9 is a view illustrating transition of peak area values of mipomersen-OMe (240 continuous analyses) when nitrogen bubbling was carried out.

FIG. 10 is a view illustrating transition of peak area values of mipomersen-LNA (240 continuous analyses) when nitrogen bubbling was carried out.

FIG. 11 shows the results of confirmation of the mobile phase causing deterioration.

FIG. 12 is a view illustrating transition of peak area values of CS-A (52 continuous analyses) with or without nitrogen bubbling.

FIG. 13 is a view illustrating transition of peak area values of CS-E (52 continuous analyses) with or without nitrogen bubbling.

FIG. 14 is a view illustrating transition of peak area values of the internal standard (ΔUA-2S GlcNCOEt-6S) (240 continuous analyses) with or without nitrogen bubbling.

### DESCRIPTION OF THE EMBODIMENTS

Hereinafter, embodiments of the present invention will be described.

### Analysis Method of Analyte

One aspect of the present invention relates to an analysis method of an analyte (hereinafter may be referred to as “analysis method of the present invention”), comprising a step of subjecting a sample containing an ionic analyte to liquid chromatography using a mobile phase containing a basic ion-pair reagent and further subjecting the analyte to mass spectrometry, characterizing in conducting an operation to prevent deterioration of the mobile phase.

The basic ion-pair reagent used herein is not particularly limited provided that it is a basic compound that can form an ion pair with an ionic analyte in a mobile phase, and a basic compound such as an amine compound is preferably used.

Examples of the amine compound include an aliphatic amine having an alkyl group having 1 to 10 carbon atoms (preferably 2 to 8 carbon atoms, 2 to 6 carbon atoms, and the like), an aromatic amine having 6 to 20 carbon atoms, a heterocyclic amine having 3 to 20 carbon atoms, or salts thereof. The salt includes, but not limited to, for example, a bromide salt, a chloride salt, a hydroxide salt, a sulfate salt, a nitrate salt, a hydrochloric salt, an acetate salt, and the like.

The basic compound that is the amine compound includes tetraethylammonium hydroxide (TEA-OH), tetrabutylammonium hydroxide (TBAOH), N,N-dimethylbutylamine (DMBA), octylamine (OA), tripropylamine (TPA), N,N-dimethylhexylamine (DMHA), diisopropylamine (DIPA), N-methyldibutylamine (MDBA), propylamine (PA), triethylamine (TEA), hexylamine (HA), tributylamine (TBA), N,N-dimethylcyclohexylamine (DMCHA), N,N-diisopropylethylamine (DIEA), tetramethylethylenediamine (TMEDA), 1,8-diazabicyclo[5.4.0]undec-7-ene (DBU), dipropylammonium acetate (DPAA), dibutylammonium acetate (DBAA), diamylammonium acetate (DAAA), dihexylammonium acetate (DHAA), and the like, and is not limited thereto. Those who are skilled in the art can select an appropriate basic ion-pair reagent for each analyte and use it under appropriate conditions. One type or two more types of basic ion-pair reagents may be used.

The present inventors have diligently investigated a means of continuously analyzing ionic analytes such as oligonucleotide therapeutics in liquid chromatography-mass spectrometry while maintaining high sensitivity.

The present inventors have found a phenomenon whereby a peak intensity of an ionic analyte such as an oligonucleotide therapeutic decreases over time in liquid chromatography-mass spectrometry. The present inventors assumed that it is necessary to prevent deterioration of the basic ion-pair reagent in order to prevent the decrease in sensitivity over time in continuous analysis and investigated a means for preventing deterioration.

As a result, the present inventors have found that, as a first means, bubbling a mobile phase of liquid chromatography with inert gas to remove oxygen from the mobile phase enables to prevent deterioration of a basic ion-pair reagent, and thereby inhibit a decrease in sensitivity in liquid chromatography-mass spectrometry.

Furthermore, it has been found that, as a second means, a mobile phase containing the basic ion-pair reagent in a nonaqueous solvent is prepared and mixed with a mobile phase containing water just before injection into liquid chromatography, enabling to prevent deterioration of the basic ion-pair reagent and to inhibit the decrease in sensitivity in liquid chromatography-mass spectrometry.

The present invention has thus been completed in such a manner.

### Deterioration Prevention Step

One more specific aspect of the present invention relates to the analysis method of the present invention, wherein the operation to prevent deterioration of the mobile phase comprises bubbling the mobile phase with an inert gas.

The bubbling is not limited provided that it is an aspect of capable of removing oxygen in the mobile phase, however, bubbling, for example, can be carried out with a gas bubbling apparatus in which an inert gas is blown into a container holding the mobile phase to conduct the bubbling treatment. The flow rate of the inert gas can be changed depending on the measurement environment, the sample, the mobile phase used, the total amount of mobile phase, and the like, which is not particularly limited thereto, and it includes, for example, a rate of 0.1 to 200 mL/min, preferably a rate of 0.1 to 20 mL/min, and more preferably a rate of 0.1 to 10 mL/min, and the like.

The inert gas may be blown continuously or intermittently, and the amount of inert gas blown in may be reduced all at once or in stages. The flow rate of inert gas can be measured, for example, by using an ADM1000 manufactured by Agilent Technology Inc.

In the specific bubbling method, those whose are skilled in the art can appropriately set a flow rate by considering the size, shape, and tightness of the container containing the mobile phase to the extent that it does not influence the composition of the mobile phase or the separation in liquid chromatography. For example, after degassing in an ultrasonic bath immediately after preparing mobile phase, an inert gas may be bubbled at about 100 mL/min for several minutes, and then the flow rate of inert gas supplied may be changed to 0.1 to 10 mL/min.

One embodiment of the gas bubbling apparatus used for bubbling the mobile phase, although not limited thereto, is described below.

The gas bubbling apparatus comprises an inert gas supply piping for blowing in a high-purity inert gas supplied. The inert gas supply piping is inserted into the mobile phase container. The material, shape, and installation position (depth in the mobile phase, etc.) of the inert gas supply piping can be appropriately selected based on conventional methods. Moreover, the gas bubbling apparatus may comprise a flow rate control valve to adjust the flow rate of inert gas flowing into the inert gas supply piping. Then, the gas bubbling apparatus conducts bubbling treatment by blowing the inert gas, the flow rate of which was adjusted by flow rate control valve in the mobile phase container via the inert gas supply piping. Moreover, an outlet piping may be provided in order to discharge air containing oxygen discharged from the mobile phase out of the container. Further, means such as an apparatus, a controlling computer, or the like that manages and controls gas bubbling by the gas bubbling apparatus may be further provided, which may carry out and stop the bubbling at prescribed intervals as a performance of the management and control apparatus. Moreover, a management and control apparatus that manages and controls the gas bubbling apparatus based on the dissolved oxygen concentration measured by the densitometer may be further provided, and it may control the aforementioned gas bubbling apparatus so that when the dissolved oxygen concentration measured by the densitometer exceeds a predetermined value, the volume of inert gas blown in by the gas bubbling apparatus is increased to allow the dissolved oxygen concentration measured by the densitometer to be less than the predetermined value.

When carrying out the bubbling, as the means for managing that the bubbling is taking place, the means of managing and controlling the gas bubbling may comprise a means such as a software or the like that implements to control bubbling (for example, when the amount of gas blown in or the pressure in the container of the mobile phase falls below a specified value, a step of increasing the amount of bubbling is implemented.), and/or to measure and record the amount of inert gas blown in or the pressure in the container applied for supplying the solvent used as the mobile phase. For example, since record keeping is required as a means to ensure the reliability of results obtained upon drugs development, the means comprised in such a manner enables such requirements to be met, which is preferred.

The inert gas is not limited provided that it does not affect the analysis and can discharge dissolved oxygen, and an argon gas, a helium gas, a neon gas, a krypton gas, a xenon gas, a nitrogen gas or the like, may be used. One or more inert gases may be used.

Other aspect of the analysis method of the present invention comprises the use of a mobile phase containing a basic ion-pair reagent in a nonaqueous solvent as an operation to prevent deterioration of the mobile phase.

One embodiment of using the mobile phase containing the basic ion-pair reagent in the nonaqueous solvent, although not limited thereto, will be described below.

A mobile phase containing water and a mobile phase containing a basic ion-pair reagent in a nonaqueous solvent are separately prepared in suitable containers. In addition to these, an additional mobile phase may be used to form an appropriate mobile phase. A pump capable of pumping the liquid from the respective container is used to feed and mix each liquid into the mixer.

The mixer is not particularly limited as long as it has a function of uniformly mixing two or more liquid phases at high speed and examples thereof include a mixer that has at least one liquid distribution and mixing unit. Specifically, such a mixer may be a gradient mixer for liquid chromatography and the like.

The total flow rate upon pumping liquid into the mixer is not particularly limited as long as two or more liquids can be contact-mixed at high speed and may be adjusted as appropriate by those who are skilled in the art depending on the type of mixer, internal volume, pump type, and other factors. Specifically, the total flow rate of liquid includes at least 0.25 times, 2.5 times, 25 times, 250 times, 2500 times, 25,000 times, or the like per minute relative to the internal volume in the mixer.

The mixing ratio of the mobile phase containing water, the mobile phase containing the basic ion-pair reagent in the nonaqueous solvent, and another mobile phase may be appropriately adjusted according to the type of solvent, the concentration of solution, the analyte, type of liquid chromatography column, and the like. The mobile phase conditions in the usual liquid chromatography-mass spectrometry conditions by using basic ion-pair reagents may be referred.

The nonaqueous solvent as used herein includes not only a solvent that contains no water at all, but also that excludes water as much as possible. For example, the organic solvent ratio can be 40% or more, 50% or more, 60% or more, 70% or more, 80% or more, or 90% or more, particularly preferably 40% or more, more preferably 60% or more, and most preferably 80% or more.

The nonaqueous solvent is not particularly limited as long as it does not affect the analysis system and does not degrade the basic ion-pair reagent, and examples thereof include organic solvents, for example alcohols such as methanol, ethanol, and propanol, and acetonitrile and the like. One type or two or more types of nonaqueous solvents may be used. The bubbling of mobile phase as described above may be carried out for a mobile phase containing the basic ion-pair reagent in the nonaqueous solvent.

One embodiment of the mobile phase includes, although not limited thereto, for example, the following phases such as
Mobile phase A: Water
Mobile phase B: Methanol
Mobile phase C: Methanol/hexafluoroisopropanol/triethylamine

The first embodiment that prevents deterioration of the mobile phase by bubbling with an inert gas, and the second embodiment that prevents deterioration of the mobile phase by using the nonaqueous solvent, may be combined for implementation, and the order in which the first embodiment and the second embodiment are conducted may be switched.

### Samples

The sample to be used in the present invention is not particularly limited, and includes, for example, samples derived from pharmaceuticals, samples derived from organism, samples derived from foods, and the like. The samples derived from pharmaceuticals include, for example, pharmaceuticals, raw materials for pharmaceuticals, and additives for pharmaceuticals. The samples derived from organism may be derived from any part of living organisms, such as epithelia, epithelial glands, connective tissues, bones, blood, hematopoietic organs, muscles, nerves, visual organs, auditory organs, a lymphatic system, an ectoderm system, a cardiovascular system, a respiratory system, a urinary system, upper digestive tracts, lower digestive tracts, digestive glands, a neuroendocrine system, an endocrine system, a reproductive system, sperms, and eggs, can be used, and they may include, for example, secretions, discharges, or swabs of whole blood, plasma, serum, breast milk, saliva, urine, stool, sputum, semen, vagina, nose, rectum, urethra or pharynx, lacrimal duct secretions, biopsy tissue samples, brain-derived samples, liver-derived samples, kidney-derived samples, skin-derived samples, muscle-derived samples, heart-derived samples, esophagus-derived samples, stomach-derived samples, small intestine-derived samples (may be derived from tissues spanning any or a plurality of duodenums, jejunums, or ileums), appendix-derived samples, large intestine-derived samples (may be derived from tissues spanning any or a plurality of ceca, ascending colons, transverse colons, descending colons, sigmoid colons, or rectums), anus-derived samples, gallbladder-derived samples, pancreas-derived samples, ureter-derived samples, spleen-derived samples, bladder-derived samples, adrenal gland-derived samples, blood vessel-derived samples, lymphatic vessel-derived samples, lymph node-derived samples, tongue-derived samples, or eyeball-derived samples (may be samples derived from tissues spanning any or a plurality of vitreous bodies, ora serrata, ciliary muscles, ciliary zonules, Schlemm’s canals, pupils, anterior chambers of the eye, corneas, irises, lens cortices, lens nuclei, ciliary processes, conjunctivas, inferior oblique muscles, inferior rectus muscles, medial rectus muscles, arteriovenous veins of retina, optic nerve papillae (optic discs), or dura maters, central retinal arteries, central retinal veins, optic nerves, vena cavae, tenon sacs, maculae, central fossae, sclerae, choroids, superior rectus muscles, retinas), and the like, however, they are not limited thereto. The samples derived from foods include, for example, foods, food ingredients, food additives, and the like. The form of the sample is not particularly limited, and can be, for example, a liquid sample or a solid sample. In the case of the solid sample, a mixture, an extract, a dissolved solution, and the like can be prepared by using a solvent or the like and used as the sample. The solvent is not particularly limited as long as it can dissolve the sample and does not influence the subsequent separation and detection, and includes water, a saline, a buffer solution, and the like. The aforementioned samples may be, for example, those containing analytes or samples that may or may not contain the analytes. The above samples may be subjected to pretreatment as appropriate prior to analysis by the method of the present invention.

### Analyte

The analyte is not limited as long as it is an ionic substance and contains various substances that are usually subjected to liquid chromatography-mass spectrometry. The ionic substance in the present invention refers to a compound having a group that can be ionized and may be a homopolymer of monomers having groups that can be ionized, a copolymer with other monomers, or a condensed polymer. The ions are not limited as long as they are anionic and may be a compound having a group that can be anions. Moreover, it may also be an amphoteric substance that also has a group that can be cationized (hereinafter may be referred to as an anionic or amphoteric substance). In particular, the analysis method of the present invention can prevent the deterioration of triethylamine and the like as the basic ion-pair reagent and can prevent the deterioration of the mobile phase. Therefore, from the viewpoint of preferably exhibiting the effect of the analysis method of the present invention, an anionic or amphoteric analyte is preferably used. Examples of such an analyte include, but are not limited to, nucleosides containing a purine compound, a purine compound analogue, a pyrimidine compound, or a pyrimidine compound analogue, nucleotides, cyclic nucleotides, nucleotide diphosphate, and nucleotide triphosphate, coenzymes containing a nucleoside such as nicotinamide adenine dinucleotide phosphate (NAD, NADPH), flavin adenine dinucleotide (FAD, FADH), coenzyme A, tetrahydromethanopterin (H4MPT), S-adenosylmethionine (SAM), and 3′-phosphoadenosine-5′-phosphosulfate, metabolic intermediates thereof as well as reduced hydrogen acceptors and modifiers thereof, oligonucleotides, saccharides, glycans, and the like. The molecular weight of the analyte is not limited as long as it can be analyzed by the liquid chromatography-mass spectrometry. The analyte contained in the sample may be one type or two more types thereof.

The oligonucleotide that is the analyte of the present invention is not particularly limited and can be a nucleic acid that is DNA or RNA, or a modified nucleic acid. Preferred examples of the oligonucleotide include an oligonucleotide therapeutic, and oligonucleotides used in oligonucleotide therapeutics such as antisense, a decoy, siRNA, miRNA, a ribozyme, CpG oligo and an aptamer. The modification of these oligonucleotides is not particularly limited, and may be such that the stability in vivo is enhanced by using methods well known per se, such as modification at the 2′ position of a saccharide moiety (2′-F, 2′-O-Methyl (2′-OMe), 2′-O-Methoxyethyl (2′-MOE), etc.), cross-linking modification (2',4′-BNA (2′,4′-Bridged Nucleic Acid, LNA (alias) (Locked Nucleic Acid (LNA), etc.), phosphorothioation of a phosphate moiety (replacing an oxygen atom double-bonded to phosphorus with a sulfur atom in a phosphate ester moiety), and methylation of a nucleic acid moiety (5-methylcytosine (5-mC), etc.).

The oligonucleotide is not particularly limited and may have, for example, 10 to 100 bases, 10 to 80 bases, 10 to 50 bases, 10 to 50 bases, or 10 to 30 bases.

The saccharide and glycans that are the analytes of the present invention are not limited and may be monosaccharides, disaccharides, or oligosaccharides, and whether they are each derived from either a simple saccharide composed only of saccharide or a complex saccharide containing other substances (containing proteins, lipids, synthetic polymers, etc.), or natural or synthetic products, does not matter. The saccharide and glycan in the present invention each may be in a state in which a glycan or glycoconjugate such as a glycoprotein, a glycolipid, or a proteoglycan is bonded to the saccharide and glycan, however when analyzing a trace amount of a glycan or glycoconjugate such as those derived from living organisms, the saccharide and glycan portion may be isolated and recovered to be used as the analytes. This pretreatment method can be selected by those who are skilled in the art depending on the properties or the like of the analyte, and then the conditions thereof can be set for use. These pretreatment methods include, but are not limited to, for example, a method for cleaving glycans with an enzyme such as peptide N-glycosidase F (PNGaseF), chondroitinase, or heparinase, fragmentation of protein portions by proteases such as trypsin and actinase, chemical hydrazine decomposition, reductive alkylation using urea and surfactants, such as sodium dodecyl sulfate (SDS), and the like.

Further, the glycan and glycoconjugate can also be appropriately cleaved and used for analysis by using enzymes such as exoglycosidase, depending on the purpose of measurement.

Preferred examples of the saccharide that is the analyte of the present invention are monosaccharides such as glucose, galactose, mannose, fucose, xylose, glucosamine, N-acetylglucosamine, galactosamine, and N-acetylgalactosamine, glucuronic acid, iduronic acid, and fructose, and disaccharides such as maltose, trehalose, sucrose, lactulose, isomaltose, lactose, lactosamine, N-acetyllactosamine, cellobiose, melibiose, fragments of glycosaminoglycans (chondroitin sulfate, dermatan sulfate, keratan sulfate, heparin, heparan sulfate, hyaluronic acid, etc.), and oligosaccharides such as fragments of maltooligosaccharides, isomaltooligosaccharides, lactooligosaccharides, lactosamine oligosaccharides, N-acetyllactosamine oligosaccharides, cellooligosaccharides, meribio oligosaccharides, and glycosaminoglycans, and the monosaccharides may be polyhydroxyaldehydes, polyhydroxyketones, and derivatives thereof (for example, amino saccharides with amino groups, carboxylic acids in which the portions of the aldehydes or primary hydroxy groups are carboxyl groups, polyhydric alcohols in which the aldehydes or ketone groups are hydroxy groups, and the like), which have about the same number of oxygen atoms as carbon atoms, as well as condensed polymers thereof. Further, sialic acid that is present at reducing ends of a glycan and a glycoconjugate bonded to a protein, a lipid, etc., and is present at ends of the glycan and an oligosaccharide as a constituent of the glycan and the glycoconjugate, can be used as the analyte. In this case, the sialic acid contains a sialic acid derivative in which the hydroxyl group is modified by acetylation or the like, and even if it is present alone, it can be the analyte.

The molecular weights of the saccharides and glycans are not limited, however may be, for example, 100 to 5,000 Da, 300 to 3,000 Da, 400 to 1,000 Da, or the like as weight-average molecular weights (Da) by a GPC-HPLC method.

### Liquid Chromatography/Mass Spectrometry

The measurement of samples in the analysis method of the present invention is conducted by using liquid chromatography (LC) and mass spectrometer (MS). The measurement may be measurement using a liquid chromatography apparatus and a mass spectrometer used, and each apparatus may be connected in series with each other. As the apparatus used for the method of the present invention, for example, an LC-MS system, which is configured of a liquid chromatography system and a mass spectrometer connected in series, is preferably used. The LC-MS system allows components separated by liquid chromatography to be subsequently analyzed by mass spectrometry. As LC-MS in which a mass spectrometer connected to liquid chromatography, tandem LC-MS/MS, LC-MS/MS/MS, or the like, can also be used.

### Liquid Chromatography Apparatus

The liquid chromatography apparatus is not particularly limited as long as it is an apparatus capable of separating an analyte contained in a sample by liquid chromatography, however, is usually preferably an HPLC apparatus. The HPLC apparatus comprises a separation column and a pump that pumps the mobile phase to the separation column. The HPLC apparatus may comprise other elements, such as a degasser, an autosampler, a heater, and detectors to detect the separated component. The detectors include, for example, a UV detector and a fluorescence detector. For example, the detectors can be connected between the column and the ion source (ionization portion).

As the liquid chromatography (LC), Ultra High Performance Liquid Chromatography (hereinafter may be referred to as UHPLC, UPLC, etc.), enabling more rapid separation analysis with higher sensitivity, may be used. UHPLC refers to liquid chromatography capable of high-pressure pumping at approximately 100 MPa and an apparatus enabling analysis at a higher speed/higher resolution. In addition to the aforementioned HPLC, the present invention also encompasses pieces of apparatus referred to as UHPLC, UPLC, etc. These pieces of apparatus are common in that they each comprise a pump that pumps the mobile phase to the separation column, and may comprise other elements, such as a degasser, an autosampler, a heater, detectors, and the like. The detectors include, for example, an UV detector and a fluorescence detector.

UPLC uses a column filled with particles that can withstand high pressure and enables more quick separation analysis with higher sensitivity than the HPLC apparatus. The separation conditions with UPLC can be set in the same manner as when setting conditions for HPLC, and those who are skilled in the art can appropriately set the conditions. Moreover, when applying the conditions of a known HPLC analysis method to UPLC, the conditions can be examined by using a software such as ACQUITY UPLC Columns Calculator.

Upon bubbling of the mobile phase of liquid chromatography with an inert gas, as the means for managing that the bubbling is taking place, the means of managing and controlling the gas bubbling may comprise a means such as a software or the like that implements to control the bubbling, and/or to measure and record the amount of inert gas blown in or the pressure in the container applied for supplying the solvent used as the mobile phase. For example, since record keeping is required as a means to ensure the reliability of results obtained upon drugs development, the means comprised in such a manner enables such requirements to be met, which is preferred. The software may be used to manage such measurement records and set bubbling conditions. In such cases, measurement records may be managed, and bubbling conditions may be set in a software that controls measurement conditions in a mass spectrometer, HPLC or UHPLC apparatus, or the software may be used as an independent and separate software. For example, when using an LC-MS system configured of a liquid chromatography system and a mass spectrometer connected in series, the HPLC or UHPLC conditions may be controlled on the mass spectrometer side, and in such a case, a software that manages measurement records and sets bubbling conditions in a computer connected to the mass spectrometer, can be used.

### Mobile Phase

The mobile phase (separation solution) used in the high-performance liquid chromatography is not particularly limited as long as it satisfies the conditions of capable of separating the analyte and being a solvent applicable to the mass spectrometer. For example, water, methanol, ethanol, isopropanol, acetonitrile, and the like can be used. One or more types of solvents may be used. The mobile phase may contain other components as long as the analyte can be analyzed.

For example, in the case of measurement of an ionic substance such as an oligonucleotide therapeutic or the like, which may have a phosphate group or a thiophosphate group, for example, acetylacetone and methanol as the mobile phase is preferably used for analysis. By using acetylacetone, peak shape defects and elution of carryover peaks due to coordination bonding of a phosphate group or a thiophosphate group of the ionic substance with metal ions can be improved, enabling to detect them, which is preferred. EDTA that has the similar effect to acetylacetone, may be used. Moreover, the utilization of methanol also enables elution time of an oligonucleotide, a saccharide, a glycan, and the like of the ionic substance to be adjusted, which is also preferred.

In the analysis method of the present invention, the mobile phase of liquid chromatography contains a basic ion-pair reagent such as triethylamine (TEA) as an ion-pair reagent in order to form an ion pair with an anionic or amphoteric sample and to enable separation in a reversed phase column. The concentration of the basic ion-pair reagent in the mobile phase can be appropriately set depending on the analyte by those skilled in the art, and for example, when using triethylamine, the concentration can be selected according to various conditions such as the type of analyte, the type of column, and the like. It may be, for example, 1 to 50 mM, 1 to 20 mM, or the like.

Further, for the purpose of facilitating separation, promoting vaporization of the basic ion-pair reagent, and the like, an additive that does not influence the analysis can be added to the mobile phase. Examples of the additive that can be used include acetic acid, ammonium hydroxide, ammonium formate (salt concentration = 100 mM or less), ammonium acetate (salt concentration = 100 mM or less), ammonium hydrogen carbonate (salt concentration = 100 mM or less), trifluoroacetic acid (TFA), tetrahydrofuran (THF), hexafluoroisopropanol (HFIP), pentafluoropropanol (PFP), 1,1,1,3,3,3-hexafluoro-2-methyl-2-propanol (HFMIP), trifluoroethanol (TFE), nonafluoro-tert-butyl alcohol (NFTB), or the like.

### Liquid Chromatography Conditions

The conditions of the analytical column used in the liquid chromatography are not particularly limited and can be appropriately selected according to various conditions such as the type of analyte and the type of sample. The separation column for use can be a reversed-phase column and is not limited thereto. The reversed-phase column includes, for example, a column using ethylene-bridged hybrid (BEH) particles that are highly resistant to an alkaline mobile phase, a column filled with an octadecylsilylated silica gel filling material (ODS column), a C8 column, a C2 column, a column in which an ion exchange resin is compounded therewith, and the like. In particular, for analysis by HPLC, a column filled with ethylene-bridged hybrid particles having a particle diameter of 5.0 µm or less (BEH column) is preferably used, and the BEH column having a particle diameter of 1.7 to 3.5 µm is more preferred.

Other various conditions used in the liquid chromatography are not particularly limited and can be appropriately selected depending on various conditions such as the type of the analyte and the type of sample, so that the analyte contained in the sample is separated from other components and eluted from the column.

Namely, the concentration of the mobile phase such as methanol in the mobile phase can be changed in the separation step. Methanol may or may not be contained in the mobile phase over the entire period of the separation step.

Although an isocratic elution method or a gradient elution method can be appropriately selected for the elution method, it is of course necessary to sufficiently separate the substance to be measured from impurities that can be confirmed on the chromatogram, and the retention time is preferably kept long because a component derived from the matrix, which cannot be confirmed on the chromatogram, has a possibility to adversely affect the ionization efficiency.

Specific gradient conditions include, for example, conditions described in the Examples below. The gradient conditions are not particularly limited, and, for example, ethanol, isopropanol, acetonitrile and the like can be used in place of methanol.

Specifically, the separation step may comprise a step of increasing the methanol concentration in the mobile phase. Namely, for example, a concentration gradient can be applied to the methanol concentration so that the methanol concentration (v/v) in the mobile phase gradually increases from a primary concentration (M1) to a second concentration (M2). M1 and M2 can be appropriately set according to various conditions such as the type of analyte and the type of impurities. The methanol concentration may be, for example, 0% or more, 1% or more, 3% or more, 5% or more, 10% or more, 20% or more, or 50% or more, and it may be 100% or less, 99% or less, 75% or less, 50% or less, 25% or less, 20% or less, 15% or less, or 10% or less. The methanol concentration may specifically be, for example, 10% to 90%. Specifically, a concentration gradient may be applied to the methanol concentration so that, for example, the methanol concentration (v/v) in the mobile phase gradually increases from 0% to 100%. The rate of change in methanol concentration may or may not be constant. The methanol concentration may be increased and decreased repeatedly by changing from M1 to M2. The methanol concentration may further change after having reached M2. For example, the methanol concentration may further increase, decrease, or repeatedly increase or decrease after having reached M2. For example, after the methanol concentration reached M2, it may repeatedly increase or decrease until it changes to M1 again. For example, it may decrease to 0% after having reached M2.

The concentration gradient can be formed by mixing two or more types of solutions having different compositions with changing a mixing ratio. The combination of solutions can be appropriately selected so that the desired gradient is formed.

When the mobile phase is prepared by mixing the two or more types of solutions, the concentration of methanol in the two or more types of solutions can be appropriately set according to the mixing ratio so that the concentration of methanol in the mobile phase after mixing becomes the concentration of methanol in the mobile phase as exemplified above.

The pH of the mobile phase can be appropriately set according to various conditions such as the type of analyte and the type of impurities. The composition of the mobile phase and the preferred range of pH can be set so that the ionization efficiency of the analyte in mass spectrometry, which is implemented subsequent to liquid chromatography, is high. Namely, specifically, the composition of the mobile phase and the pH thereof upon elution of the analyte from the column are preferably set so that the ionization efficiency of the analyte is high in the mass spectrometry. As a specific range of pH, for example, pH of 1 to 14 is favorable, pH of 4 to 12 is preferred, and the vicinity of 6 to 10 of pH is even more preferred.

The flow rate can be appropriately selected according to various conditions, such as the inner diameter of the separation column. The flow rate of the mobile phase may or may not be constant throughout the separation step. For example, it can be appropriately selected in the range of 0.001 to 2.0 mL/min in accordance with an electrospray method (ESI). The flow rate of the mobile phase in liquid chromatography may be, for example, 0.05 to 1.0 mL/min.

Moreover, the column temperature in the liquid chromatography can be selected by those who are skilled in the art according to the analyte and the specifications of the analytical column to be used. For example, it may be 10 to 90° C., specifically approximately 30 to 80° C.

### Mass Spectrometer

The mass spectrometer can be any publicly known mass spectrometer, and the mass spectrometers that can be connected in series to an LC apparatus are used easily, which is preferred. The mass spectrometer to be used may be one, or two or more. Two or more mass spectrometers can be connected in parallel for use. Further a LC-MS system may be, for example, LC-MS, LC-MS/MS or LC-MSⁿ. Specifically, it includes, for example, Triple Quad (registered trademark) 5500, Triple Quad (registered trademark) 6500, Triple Quad (registered trademark) 6500+, QTRAP (registered trademark) 5500, QTRAP (registered trademark) 6500, QTRAP (registered trademark) 6500+, TripleTOF (registered trademark) 5600, TripleTOF (registered trademark) 5600+, TripleTOF (registered trademark) 6600, TripleTOF (registered trademark) 6600+, and the like, which are manufactured by AB Sciex Pte. Ltd., Q Exactive (trademark) Focus, Q Exactive (trademark), Q Exactive (trademark) Plus, Q Exactive (trademark) HF, Q Exactive (trademark) HF-X, Orbitrap ID-X Tribrid, Orbitrap Fusion (trademark) Tribrid (trademark), Orbitrap Fusion (trademark), Lumos (trademark), Tribrid (trademark), Orbitrap Eclipse, and the like, which are manufactured by Thermo Fisher Scientific Inc.

Examples of the detection system in the mass spectrometer include, for example, an ion trap type, a quadrupole type, a quadrupole tandem type, a quadrupole ion trap hybrid type, a sector type, a flight time type, a quadrupole flight time hybrid type, and Fourier transform type, a quadrupole Fourier transform hybrid type, and the like. Further, an ion mobility system can be mounted thereon. Examples of the ionization method in the mass spectrometer include an electrospray method (ESI), an atmospheric chemical ionization method (APCI), a photoionization method (APPI), and the like. The detection method and the ionization method can be appropriately selected according to various conditions such as the type of the analyte.

Since a spectrum and a fragment ion spectrum (including an accurate mass spectrum) obtained by the mass spectrometry are values inherent to a substance, by comparing the ion ratio obtained by analysis of a standard product with the spectrum or fragment ion spectrum (including an accurate mass spectrum) obtained by analysis of a sample, the analyte contained in the sample can be identified. Specifically, a purified or synthesized analyte for an analyte is used as a standard product, and the spectrum (including the accurate mass spectrum) obtained by analyzing the standard product and the chromatogram obtained from the sample of the analyte may be compared to identify the analyte contained in the sample.

Moreover, if an analyte, for which any standard product does not exist, is an unknown analyte, for example, it can be applied to the analysis of the present invention after having confirmed that the substance separated by liquid chromatography was identical to the analyte by assuming the structure thereof and the like. Those who are skilled in the art can appropriately select and implement methods for confirming an unknown analyte, and for example, can confirm it being the analyte by isolation and purification thereof.

Based on the results of mass spectrometry, the analyte can be quantified. Quantification of the analyte can be carried out by ordinary methods. Specifically, for example, the analyte can be quantified based on the peak area ratio (or peak height ratio) obtained by dividing the peak area value (or peak height value) of the detected analyte by the peak area value (or peak height value) of an internal standard with known concentration.

The liquid chromatography apparatus, the mass spectrometer, and the various elements comprised therein can be appropriately selected according to various conditions, such as the type of analyte and the type of impurities by referring to the analysis conditions exemplified above.

### Method for Preventing Deterioration of Mobile Phase

A further aspect of the present invention relates to a method for preventing deterioration of the mobile phase, including bubbling the mobile phase of liquid chromatography, containing the basic ion-pair reagent (hereinafter may be referred to as the “first method for preventing deterioration of the mobile phase of the present invention”).

A further aspect of the present invention relates to a method for preventing deterioration of the mobile phase, comprising the step of preparing a mobile phase in which the basic ion-pair reagent is dissolved in a nonaqueous solvent, mixing the mobile phase with a mobile phase containing water, and using the mixture for liquid chromatography (hereinafter referred to as the “second method for preventing deterioration of the mobile phase of the present invention”).

The first method for preventing deterioration of the mobile phase and the second method for preventing deterioration of the mobile phase enable to prevent deterioration of the mobile phases by preventing deterioration of the basic ion-pair reagents in the mobile phases in the liquid chromatography and the liquid chromatography-mass spectrometry.

Of note, the items described in the aforementioned analysis method of the present invention are all applicable to the description of the method for preventing deterioration of the mobile phase of the present invention.

### Analytical Apparatus

A further aspect of the present invention relates to pieces of analytical apparatus (hereinafter referred to as “analytical apparatus of the present invention”), comprising: a liquid chromatography apparatus separating a sample containing an ionic analyte by using the mobile phase containing the basic ion-pair reagent, a mass spectrometer, which analyzes the analyte, and a deterioration prevention apparatus of the mobile phase.

It is noted that the items described in the aforementioned analysis method and the method for preventing deterioration of the mobile phase, of the present invention are all applicable to the description of the analytical apparatus of the present invention.

One embodiment of the analytical apparatus of the present invention, which is not limited thereto, will be described below:
(1) A container for supplying a mobile phase containing a basic ion-pair reagent,
(2) A pump having a function of pumping the mobile phase,
(3) A gas bubbling apparatus for blowing in an inert gas into the mobile phase to conduct bubbling treatment,
(4) A liquid chromatography apparatus for separating a sample containing an analyte,
(5) A mass spectrometer to analyze the analyte.

Another embodiment of the analytical apparatus includes a form further comprising a means and a software for managing and controlling bubbling of the mobile phase.

Another embodiment of the analytical apparatus of the present invention will be described below:
(1) A container for supplying a mobile phase containing water and a container for supplying a mobile phase containing a basic ion-pair reagent in a nonaqueous solvent,
(2) A pump having the function of pumping each of the above liquids to a mixing section,
(3) A mixer having the function of uniformly mixing the two liquids at high speed,
(4) A liquid chromatography apparatus for separating a sample containing an analyte by using the mixed liquid produced as the mobile phase,
(5) A mass spectrometer to analyze the analyte.

Another one further embodiment of the analytical apparatus of the present invention will be described below:
(1) A container for supplying a mobile phase containing water, a container for supplying a mobile phase containing an organic solvent, and a container for supplying a mobile phase containing a basic ion-pair reagent in a nonaqueous solvent,
(2) A pump having the function of pumping each of the above liquids to a mixing section,
(3) A mixer having the function of uniformly mixing the three liquids at high speed,
(4) A liquid chromatography apparatus for separating a sample containing an analyte by using the obtained mixed liquid as the mobile phase,
(5) A mass spectrometer that analyzes the analyte.

It is noted that the aforementioned description is only an example and does not indicate the limits of application of the analytical apparatus according to the present invention. Namely, the analytical apparatus according to the present invention is not limited to the embodiments in the present description, and various modifications are possible as long as they do not exceed the gist of the present invention.

### EXAMPLES

The present invention will be specifically described by way of the following Examples, which are not intended to limit the scope of the present invention.

### Example 1: Preparation of Standard Solutions

### Materials

The following mipomersen (mipomersen-MOE) and mipomersens produced by using other modified nucleic acids (mipomersen-LNA, mipomersen-OMe, mipomersen-S oligo) were purchased from Gene Design Inc. and used as standard materials.
Mipomersen-MOE (Mip-MOE)
   G(m)^5(m)^5(m)^T(m)^5(m)^a^g^t^5(x)^t^g^5(x)^t^t^5(x)^G(m)^5(m)^A(m)^5(m)^5 (m)
Mipomersen-LNA (Mip-LNA)
   G(L)^5(L)^5(L)^T(L)^5(L)^a^g^t^5(x)^t^g^5(x)^t^t^5(x)^G(L)^5(L)^A(L)^5(L)^5(L)
Mipomersen-OMe (Mip-OMe)
   G(M)^5(M)^C(M)^T(M)^C(M)^a^g^t^5(x)^t^g^5(x)^t^t^5(x)^G(M)^C(M)^A(M)^C( M)^C(M)
Mipomersen-S oligo (Mip-S-oligo)
   g^5(x)^5(x)^t^5(x)^a^g^t^5(x)^t^g^5(x)^t^t^5(x)^g^5(x)^a^5(x)^5(x)

TABLE 1

| | |
|---|---|
| Notation details | |
| a, t, g | = DNA |
| 5(x) | = 5-mC DNA |
| A(m), T(m), G(m), mC :5(m) | = 2′ -MOE RNA |
| A(L), T(L), G(L). mC :5(L) | = LNA |
| A(M), T(M), G(M), C (M) | = 2′ -OMe RNA |
| ^ | = Phosphorothioated |

### Preparation of Reagents

Solvents were prepared by using methanol (for LC/MS, manufactured by Wako Pure Chemical Industries, Ltd.), 1,1,1,3,3,3-hexafluoro-2-propanol (HFIP) (for HPLC, manufactured by NACALAI TESQUE, INC.), triethylamine (TEA) (sequencing grade, manufactured by Thermo Fischer Scientific Inc.), acetylacetone (special grade, manufactured by KANTO CHEMICAL CO., INC.), and a tris-EDTA buffer (TE) (manufactured by NIPPON GENE CO., LTD.) were used.

### (i) Preparation of TE/methanol (7:3, v/v)

3 volumes of methanol were mixed with 7 volumes of TE.

### (ii) Preparation of water/methanol/HFIP/TEA/acetylacetone (90:10:1:0.2:0.01, v/v/v/v/v)

90 volumes of water, 10 volumes of methanol, 1 volume of HFIP, 0.2 volumes of TEA, and 0.01 volumes of acetylacetone were mixed. The container was covered with an aluminum foil and shielded from light.

### (iii) Preparation of water/methanol/HFIP/TEA (90:10:1:0.2, v/v/v/v)

90 volumes of water, 10 volumes of methanol, 1 volume of HFIP, and 0.2 volumes of TEA were mixed. The container was covered with an aluminum foil and shielded from light.

### (iv) Preparation of methanol/water/HFIP/TEA/acetylacetone (90:10:1:0.2:0.01, v/v/v/v/v)

90 volumes of methanol, 10 volumes of water, 1 volume of HFIP, 0.2 volumes of TEA, and 0.01 volumes of acetylacetone were mixed. The container was covered with an aluminum foil and shielded from light.

### (v) Preparation of methanol/water/HFIP/TEA (90:10:1:0.2, v/v/v/v)

90 volumes of methanol, 10 volumes of water, 1 volume of HFIP, and 0.2 volumes of TEA were mixed. The container was covered with an aluminum foil and shielded from light.

### (vi) Preparation of water/methanol/HFIP/TEA/acetylacetone (50:50:1:0.2:0.01, v/v/v/v/v)

50 volumes of water, 50 volumes of methanol, 1 volume of HFIP, 0.2 volumes of TEA, and 0.01 volumes of acetylacetone were mixed.

### Preparation of standard solutions

Mipomersen-MOE, mipomersen-LNA, mipomersen-OMe, and mipomersen-S oligo were dissolved in DNase, RNase-free purified water.

323 µL of purified water was added to 231.8 µg of mipomersen-MOE to completely dissolve the mixture and prepare a solution with a concentration of 100 µmol/L, which was used as a mipomersen-MOE standard solution. 327 µL of purified water was added to 219.8 µg of mipomersen-LNA to completely dissolve the mixture and prepare a solution with concentration of 100 µmol/L, which was used as a mipomersen-LNA standard solution. 358 µL of purified water was added to 238.3 µg of mipomersen-OMe to completely dissolve the mixture and prepare a solution with concentration of 100 µmol/L, which was used as a mipomersen-OMe standard solution. 349 µL of purified water was added to 224.6 µg of mipomersen-S oligo to completely dissolve the mixture and prepare a solution with concentration of 100 µmol/L, which was used as a mipomersen-S oligo standard solution.

The standard solutions of mipomersen-MOE, mipomersen-LNA, mipomersen-OMe, and mipomersen-S oligo were diluted 500-fold with water/methanol/HFIP/TEA/acetylacetone (50:50:1:0.2:0.01, v/v/v/v/v) and used as mass spectrometer tuning solutions for setting optimum conditions for ionization and selecting ions to be measured.

The standard solutions of mipomersen-MOE, mipomersen-LNA, mipomersen-OMe, and mipomersen-S oligo were diluted 2000-fold in TE/methanol (7:3, v/v) to prepare a mixed solution with 50 nmol/L and used as a standard solution for monitoring spectral intensity.

### Example 2: Determination of Mass Spectrometry Conditions

The mass spectrometer tuning solutions were each introduced into the ion source by using a syringe pump. Upon this, the HPLC pump (LC-20A, manufactured by Shimadzu Corporation) was used to introduce the mixed mobile phase into the ion source together with the tuning solution.

While checking the precursor ion (parent ion) to be used for quantitation, the spray position of the ion source of the mass spectrometer (TripleTOF5600, manufactured by AB Sciex Pte. Ltd.) was adjusted to maximize this ion intensity.

After completion of the spray position adjustment, the declustering potential (orifice voltage; DP), the high voltage to be applied (ion spray voltage; IS), the gas pressure of GS1 and GS2 (GS1, GS2), and the temperature (TEM) were adjusted.

Next, the product ions (daughter ions) were searched from the precursor ions (parent ions), and the energy voltage (CE) associated with the collisional cleavage was adjusted so as to maximize the ion intensity.

The mass spectrometry conditions determined by the above methods are shown in Tables 2 and 3. The common ionization conditions are shown in Table 2. The mass spectrometry conditions (MS/MS conditions) for each component are shown in Table 3. It is noted that for mipomersen-MOE, mipomersen-LNA, and mipomersen-OMe, 9-valent ions and 10-valent ions were used as precursor ions, and for mipomersen-S oligo, 8-valent ions and 9-valent ions were used as precursor ions.

TABLE 2

Ionization conditions

| Ionization mode | Negative ESI | | | |
|---|---|---|---|---|
| Ion source | IS | GS1 | GS2 | TEM |
| | -4500V | 50 psi Dry air | 50 psi Dry air | 450° C. |

TABLE 3

Mass spectrometry conditions (MS/MS conditions

| T/A | Precursor ion (Da) | Product ion (Da) | DP (V) | CE (V) |
|---|---|---|---|---|
| Mip-MOE_z9 | 796.3 | 94.9 | -150 | -65 |
| Mip-MOE_z10 | 716.6 | 94.9 | -150 | -65 |
| Mip-LNA_z9 | 745.2 | 94.9 | -150 | -65 |
| Mip-LNA_z10 | 670.5 | 94.9 | -150 | -65 |
| Mip-OMe_z9 | 738.1 | 94.9 | -150 | -65 |
| Mip-OMe_z10 | 664.2 | 94.9 | -150 | -65 |
| Mip-S-oligo_z8 | 803.4 | 94.9 | -150 | -65 |
| Mip-S-oligo_z9 | 714.1 | 94.9 | -150 | -65 |

### Example 3: Setting of HPLC Conditions»

Using the standard solution for monitoring spectral intensity prepared in Example 1, HPLC conditions of enabling separation of mipomersen-MOE, mipomersen-LNA, mipomersen-OMe, and mipomersen-S oligo, were investigated.

A Shimadzu LC-20A system (manufactured by Shimadzu Corporation) was used as the HPLC system, and an ACQUITY UPLC Oligonucleotide BEH C18 Column (particle size 1.7 µm, inner diameter 2.1 mm × length 50 mm; manufactured by Waters Corporation) was used as the HPLC column.

### HPLC condition 1

In analyzing mipomersen-MOE and mipomersen-S oligo, linear gradient conditions in which a water/methanol/HFIP/TEA/acetylacetone (90:10:1:0.2:0.01, v/v/v/v/v) (mobile phase A) was used as an aqueous mobile phase and a methanol/water/HFIP/TEA/acetylacetone (90:10:1:0.2:0.01, v/v/v/v/v) (mobile phase B) was used as an organic solvent mobile phase, were set. The flow rate was set at 0.3 mL/min. An example of gradient conditions is shown in Table 4.

TABLE 4

Gradient conditions (linear gradient)

| Time (min.) | Mobile phase B (%) |
|---|---|
| 0.00 | 0 |
| 0.50 | 0 |
| 5.00 | 50 |
| 5.01 | 100 |
| 7.00 | 100 |
| 7.01 | 0 |
| 10.00 | 0 |

### HPLC condition 2

In analyzing mipomersen-MOE, mipomersen-LNA, and mipomersen-OMe, linear gradient conditions in which a water/methanol/HFIP/TEA (90:10:1:0.2: v/v/v/v) (mobile phase A) was used as the aqueous mobile phase and a methanol/water/HFIP/TEA (90:10:1:0.2, v/v/v/v) (mobile phase B) was used as the organic solvent mobile phase, were set. The flow rate was set at 0.3 mL/min. An example of gradient conditions is shown in Table 5.

TABLE 5

Gradient conditions (linear gradient)

| Time (min) | Mobile phase B (%) |
|---|---|
| 0.00 | 5 |
| 5.00 | 30 |
| 5.01 | 100 |
| 7.00 | 100 |
| 7.01 | 5 |
| 10.00 | 5 |

### Example 4: Confirmation of Effect of Presence or Absence of Nitrogen Bubbling Of Mobile Phase on Measurement of Myomeres-MOE and Mipomersen-S Oligo

Using <HPLC condition 1>, changes in peak intensity in the continuous analysis of mipomersen-MOE and mipomersen-S oligo under the conditions of carrying out nitrogen bubbling (2 mL/min) in the mobile phase (1 L) and not carrying out it, were confirmed. In addition, the peak area ratio of mipomersen-MOE peak area value/mipomersen-S oligo peak area value was calculated, and the transition of peak area ratios in continuous analysis was also confirmed.

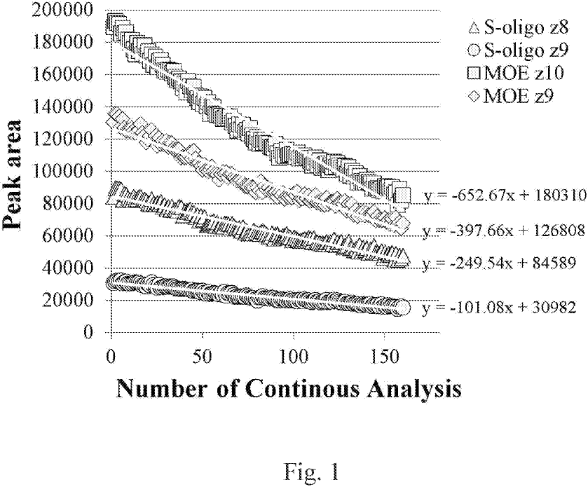

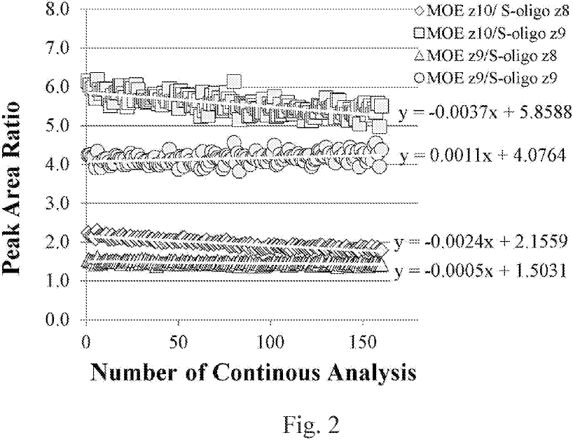

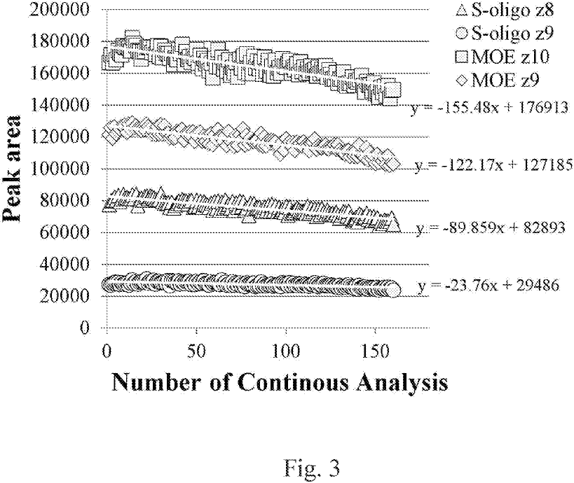

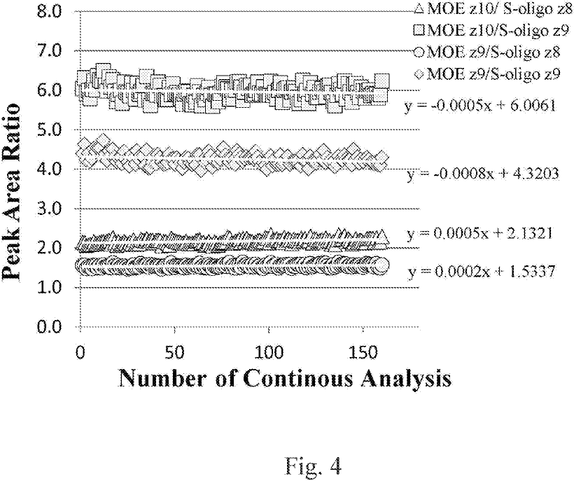

FIG. 1 shows the transition of peak area values of mipomersen-MOE and mipomersen-S oligo when nitrogen bubbling was not carried out (160 continuous analyses), FIG. 2 shows the transition of peak area ratios of mipomersen-MOE/mipomersen-S oligo when nitrogen bubbling was not carried out (160 continuous analyses), FIG. 3 shows the transition of peak area values of mipomersen-MOE and mipomersen-S oligo when nitrogen bubbling was carried out (160 continuous analyses), and FIG. 4 shows the transition of peak area ratios of mipomersen-MOE/mipomersen-S oligo when nitrogen bubbling was carried out (160 continuous analyses).

The results of this study indicated that the absolute values of the slopes of the approximate curves calculated from the peak area values shown in FIGS. 1 and 3 satisfy the relationship of the absolute value without nitrogen bubbling > the absolute value with nitrogen bubbling, revealing that the nitrogen bubbling in the mobile phase inhibits the decrease in the peak areas of mipomersen-MOE and mipomersen-S oligo. Moreover, when the peak area ratios of mipomersen-MOE and mipomersen-S oligo were determined to calculate approximate curves, assuming the internal standard method that is a mainstream method for quantitative analysis, the absolute values of the slopes showed the relationship of the absolute value without nitrogen bubbling > the absolute value with nitrogen bubbling as well. This means that when the nitrogen bubbling is applied to the mobile phase, the peak area ratios of the first run of the measurement and the 160th run from the start of the measurement are close to each other, indicating that the same sample is measured as the same quantitative value. Conversely, it means that when the nitrogen bubbling was not carried out in the mobile phase, there occurs a discrepancy in the peak area ratios between the first run of the measurement and the 160th run from the start of the measurement, indicating that the same sample is measured as a different quantitative value, and thereby the nitrogen bubbling applied in the mobile phase was clarified to be useful.

### Example 5: Confirmation of Effect of Presence or Absence of Nitrogen Bubbling Of Mobile Phase on Measurement of Mipomersen-MOE, Mipomersen-LNA, and Mipomersen-OMe

In order to confirm whether similar results can be obtained for compounds using modified nucleic acids other than those in Example 4, changes in peak intensity in the continuous analysis of mipomersen-MOE, mipomersen-LNA, and mipomersen-OMe were measured by using <HPLC condition 2> under the conditions of carrying out nitrogen bubbling to the mobile phase and not carrying out it.

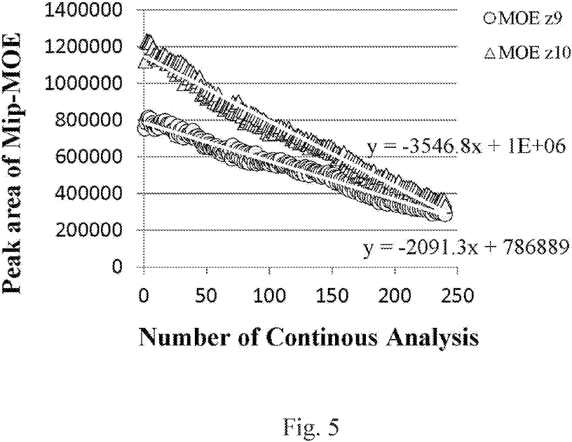

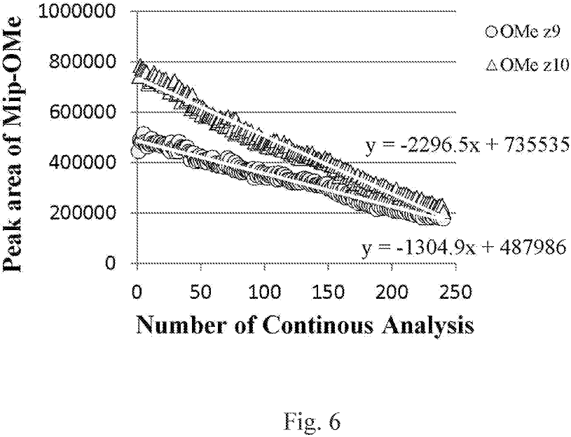

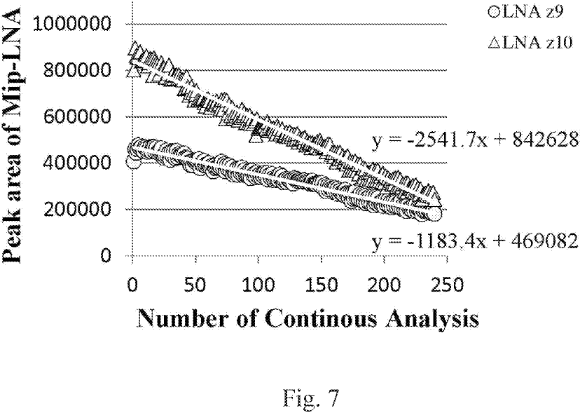

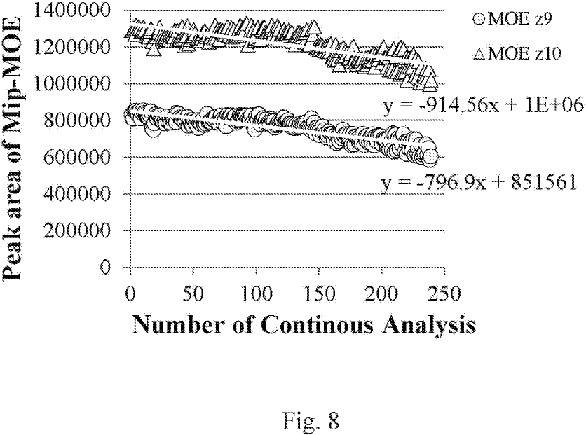

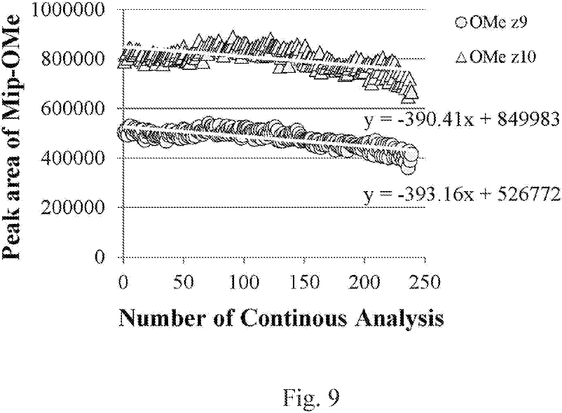

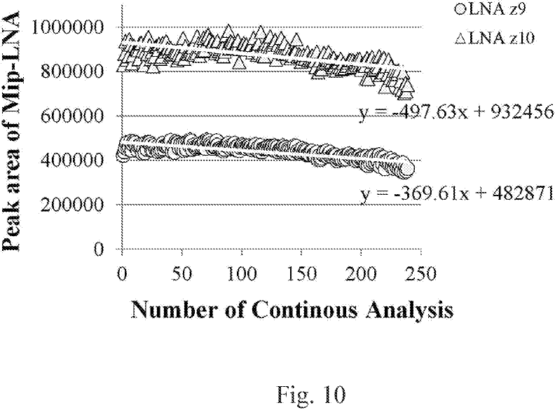

FIGS. 5 to 7 show the transition of area values of mipomersen-MOE, mipomersen-LNA, and mipomersen-OMe when nitrogen bubbling was not carried out (240 continuous analyses), and FIGS. 8 to 10 show the transition of peak area values of mipomersen-MOE, mipomersen-LNA, and mipomersen-OMe when nitrogen bubbling was carried out (240 continuous analyses).

In this study as well, the slopes of the approximate curves calculated from the transition of peak area values indicate the relationship of the slope without nitrogen bubbling > the slope with nitrogen bubbling, revealing that nitrogen bubbling of the mobile phase inhibits the decrease in the peak areas of mipomersen-MOE, mipomersen-LNA, and mipomersen-OMe. As in Example 4, the nitrogen bubbling applied in the mobile phase was clarified to be useful.

### Example 6: Improvement Approach by Changing Composition of Mobile Phase

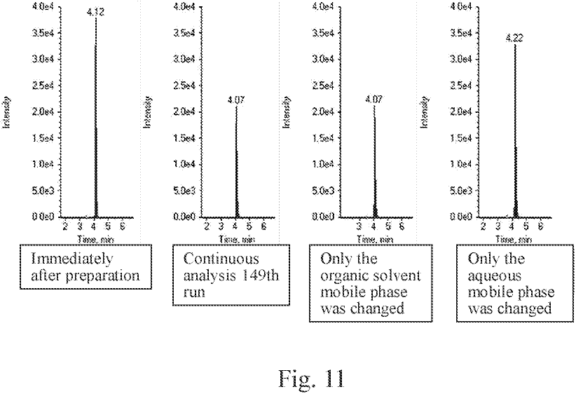

Using <HPLC condition 2>, the peak intensity in the continuous analysis of mipomersen-MOE was changed under the conditions of not carrying out nitrogen bubbling of the mobile phase. The peak intensities of mipomersen-MOE in the case of replacing only a newly prepared organic solvent mobile phase and the case of replacing only a newly prepared aqueous mobile phase were then confirmed. The results are shown in FIG. 11.

This study resulted in indicating that the aqueous mobile phase being more susceptible to deterioration than the organic solvent mobile phase. This clarifies that the deterioration speed of the mobile phase can be slowed down by creating an environment in which the basic ion-pair reagent causing the deterioration is present only in a solution with the high organic solvent ratio. Therefore, it is indicated that the deterioration can be improved by implementing the gradient analysis under the following mobile phase conditions.
Mobile phase A: Water
Mobile phase B: Methanol
Mobile phase C: Methanol/HFIP/TEA (100:1:0.2, v/v/v)
(Mobile phase C preferably undergoes nitrogen bubbling.)
Three-component gradient mode where mobile phase C always flows in an amount of 10% and mobile phase A and mobile B undergo gradient.

### Example 7: Preparation of Standard Solution

### Materials

The following ΔUA-GalNAc, 4S (Chondroitin Sulfate A) (C₁₄H₁₉NO₁₄SNa₂, MW:503.34), ΔUA-GalNAc, 4S, 6S (Chondroitin Sulfate E) (C₁₄H₁₈NO₁₇S₂Na₃, MW:605.39) and ΔUA-2S GlcNCOEt-6S (internal standard) (C₁₅H₂₀NO₁₇S₂Na₃, MW:619.42) were purchased from Iduron Ltd. and used as standards.

### Preparation of Reagents

Acetonitrile (for LC/MS, manufactured by Wako Pure Chemical Industries, Ltd.), 1,1,1,3,3,3-hexafluoro-2-propanol (HFIP) (for HPLC, manufactured by NACALAI TESQUE, INC.), and n-Octylamine (OA) manufactured by Tokyo Kasei Kogyo Co., Ltd., were used for the preparation of solvents.

### (i) Preparation of Water/HFIP/OA (100:1:0.124, v/v/v)

100 volumes of water, 1 volume of HFIP, and 0.124 volumes of OA were mixed. The container was covered with an aluminum foil and shielded from light.

### (ii) Preparation of Acetonitrile/Water/HFIP/OA (75:25:1:0.124, v/v/v/v)

75 volumes of acetonitrile, 25 volumes of water, 1 volume of HFIP, and 0.124 volumes of OA were mixed. The container was covered with an aluminum foil and shielded from light.

### Preparation of Standard Solution

Chondroitin Sulfate A, Chondroitin Sulfate E and an internal standard were dissolved in MilliQ (registered trademark) water and the respective mixture were prepared to the following concentrations.
Chondroitin Sulfate A 5 mmol/L (CS-A)
Chondroitin Sulfate E 2 mmol/L (CS-E)
Internal standard 5 mmol/L (IS)

CS-A, CS-E and IS were diluted 1000-fold with water/HFIP/OA (100:1:0.124, v/v/v) to prepare mass spectrometer tuning solutions which is used for setting optimal conditions of ionization and selecting ions to be measured.

CS-A, CS-E and IS were diluted 10,000-fold with water/HFIP/OA (100:1:0.124, v/v/v) to prepare a mixed solution which is used as a standard solution for checking changes in peak intensity in continuous analysis.

### Example 8: Determination of Mass Spectrometry Conditions

The mass spectrometer tuning solution was introduced into the ion source by using a syringe pump. At this time, the mixed mobile phase was introduced into the ion source together with the tuning solution by using an HPLC pump (LC-20A, manufactured by Shimadzu Corporation).

While checking the precursor ion (parent ion) to be used for quantification, the spray position of the ion source on the mass spectrometer (QTRAP 5500, manufactured by AB Sciex Pte. Ltd.) was adjusted so that this ion intensity became the highest.

After completion of the spray position adjustment, the declustering potential (orifice voltage; DP), the high voltage to be applied (ion spray voltage; IS), the gas pressure of GS1 and GS2 (GS1, GS2), and the temperature (TEM) were adjusted.

Next, the product ions (daughter ions) were searched from the precursor ions (parent ions) and the energy voltage (CE) associated with the collisional cleavage was adjusted to maximize the ion intensity.

The mass spectrometry conditions determined by the above method are shown in Tables 6 and 7. The common ionization conditions are listed in Table 6. The mass spectrometry conditions (MS/MS conditions) for each component are shown in Table 7.

TABLE 6

Ionization conditions

| Ionization mode | Negative ESI | | | |
|---|---|---|---|---|
| Ion source | IS | GS1 | GS2 | TEM |
| | -4500V | 50 psi Dry air | 80 psi Dry air | 600° C. |

TABLE 7

Mass spectrometry conditions (MS/MS conditions

| T/A | Precursor ion (m/z) | Product ion (m/z) | DP (V) | CE (V) |
|---|---|---|---|---|
| Chondroitin Sulfate A | 458.0 | 300.0 | -156 | -30 |
| Chondroitin Sulfate E | 538.0 | 300.0 | -110 | -43 |
| IS | 552.0 | 96.9 | -100 | -41 |

### Example 9: Setting of HPLC Conditions

Using the standard solution prepared in Example 1 for checking changes in peak intensity, HPLC conditions of enabling separation of Chondroitin Sulfate A, Chondroitin Sulfate E, and the internal standard substance were investigated.

A Shimadzu LC-20A system (manufactured by Shimadzu Corporation) was used as the HPLC system, and an ACQUITY UPLC BEH C18 column (particle size 1.7 µm, inner diameter 2.1 mm × length 100 mm; manufactured by Waters Corporation) was used as the HPLC column.

### HPLC Condition 3

In analyzing Chondroitin Sulfates A and E, linear gradient conditions in which a water/HFIP/OA (100:1:0.124, v/v/v) (mobile phase A) was used as an aqueous mobile phase and an acetonitrile/water/HFIP/OA (75:25:1:0.124, v/v/v/v) (mobile phase B) was used as an organic solvent mobile phase, were set. The flow rate was 0.2 mL/min. An example of gradient conditions is shown in Table 8.

TABLE 8

Gradient conditions (linear gradient)

| Time (min.) | Mobile phase B (%) |
|---|---|
| 0.00 | 5 |
| 30.00 | 15 |
| 30.01 | 25 |
| 35.00 | 25 |
| 35.01 | 5 |
| 40.00 | 5 |

### Example 10: Confirmation of Effect of Presence or Absence of Nitrogen Bubbling Of Mobile Phase on Measurement of Chondroitin Sulfate A, Chondroitin Sulfate E, and Internal Standard

Using <HPLC condition 3>, changes in peak intensity in the continuous analysis of Chondroitin Sulfate A, Chondroitin Sulfate E and the internal standard ΔUA-2S GlcNCOEt-6S) were confirmed under conditions of carrying out nitrogen bubbling (10 mL/min) in the mobile phase (1 L) and of not carrying out it.

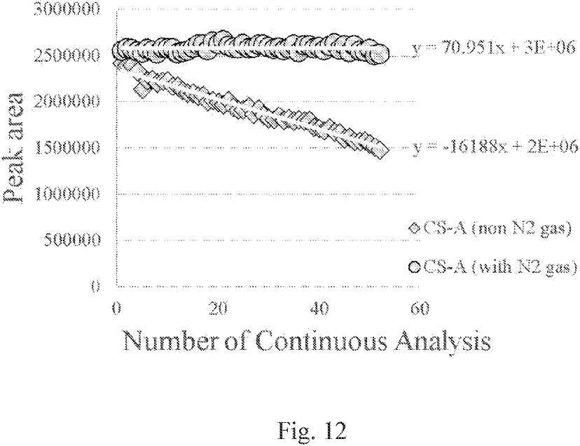

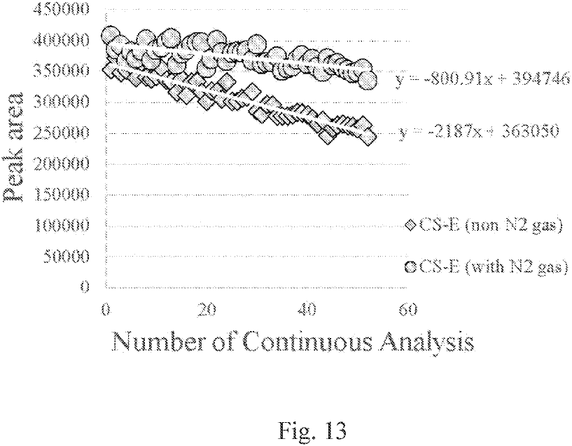

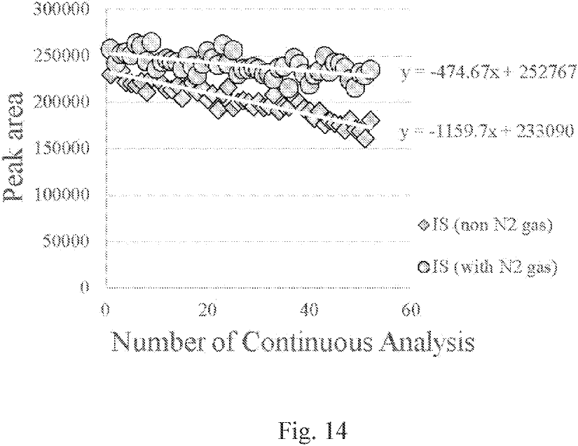

FIG. 12 shows the transition of area values of Chondroitin Sulfate A with and without nitrogen bubbling (52 continuous analyses), FIG. 13 shows the transition of area values of Chondroitin Sulfate E with and without nitrogen bubbling (52 continuous analyses), and FIG. 14 shows the transition of area values of the internal standard (ΔUA-2 S GlcNCOEt-6S) with and without nitrogen bubbling (52 continuous analyses).

This study indicates that the absolute values of the slopes of the approximate curves calculated from the transition of the peak area values shown in FIGS. 12 to 14 indicate the relationship of “without nitrogen bubbling” > “with nitrogen bubbling,” clarifying that the nitrogen bubbling in the mobile phase inhibited the decrease in the peak areas of Chondroitin Sulfate A, Chondroitin Sulfate E and the internal standard (ΔUA-2S GlcNCOEt-6S).

### Industrial Applicability

By using the method for preventing deterioration of the mobile phase of the present invention, it is possible to stably detect the peak heights, peak areas, peak height ratios, and peak area ratios of the target compound to be measured and the internal standard thereof over a long period of time in the measurement using the mass spectrometer system, enabling to subject many samples to measurement at one measurement opportunity and to obtain accurate concentration measurement values.

Moreover, the present invention eliminates the need for frequent preparation of mobile phases due to the deterioration thereof. The reagents used in the preparation of the mobile phase are very expensive, and therefore the reduction of cost burden as well as the saving of labor time for reagent preparation by a preparer, can be expected.

1. An analysis method comprising:
subjecting a sample containing an ionic analyte to liquid chromatography using a mobile phase containing a basic ion-pair reagent; and
further subjecting the analyte to mass spectrometry,
wherein the analysis method conducts an operation to prevent deterioration of the mobile phase.

2. The method according to claim 1, wherein the operation to prevent deterioration of the mobile phase comprises bubbling of the mobile phase with an inert gas.

3. The method according to claim 2, wherein the operation to prevent deterioration of the mobile phase further comprises managing and controlling the bubbling of the mobile phase with an inert gas.

4. The method according to claim 1, wherein the operation to prevent deterioration of the mobile phase comprises use of a mobile phase containing the basic ion-pair reagent in a nonaqueous solvent.

5. The method according to claim 1, wherein the basic ion-pair reagent is an amine compound.

6. The method according to claim 1, wherein the basic ion-pair reagent is at least one or more types selected from the group consisting of tetraethylammonium hydroxide (TEA-OH), tetrabutylammonium hydroxide (TBAOH), N,N-dimethylbutylamine (DMBA), octylamine (OA), tripropylamine (TPA), N,N-dimethylhexylamine (DMHA), diisopropylamine (DIPA), N-methyldibutylamine (MDBA), propylamine (PA), triethylamine (TEA), hexylamine (HA), tributylamine (TBA), N,N-dimethylcyclohexylamine (DMCHA), N,N-diisopropylethylamine (DIEA), tetramethylethylenediamine (TMEDA), 1,8-diazabicyclo[5.4.0]undec-7-ene (DBU), dipropylammonium acetate (DPAA), dibutylammonium acetate (DBAA), diamylammonium acetate (DAAA), and dihexylammonium acetate (DHAA).

7. The method according to claim 1, wherein the ionic analyte is at least one or more types selected from the group consisting of a nucleoside containing a purine compound, a purine compound analogue, a pyrimidine compound, or a pyrimidine compound analogue; a nucleotide, a cyclic nucleotide, a nucleotide diphosphate, and a nucleotide triphosphate; a coenzyme containing a nucleoside selected from nicotinamide adenine dinucleotide phosphate (NAD, NADPH), flavin adenine dinucleotide (FAD, FADH), coenzyme A, tetrahydromethanopterin (H4MPT), S-adenosylmethionine (SAM), and 3′-phosphoadenosine-5′-phosphosulfate; metabolic intermediates thereof, as well as reduced hydrogen acceptors and modifiers thereof; an oligonucleotide, a saccharide, and a glycan.

8. The method according to claim 7, wherein the oligonucleotide is at least one or more types of oligonucleotide therapeutics selected from the group consisting of antisense, a decoy, siRNA, miRNA, a ribozyme, CpG oligo, and an aptamer.

9. The method according to claim 7, wherein the saccharide and the glycan are each at least one or more types selected from the group consisting of a monosaccharide, a disaccharide, and an oligosaccharide.

10. The method according to claim 2, wherein the inert gas is at least one or more types selected from the group consisting of a nitrogen gas, an argon gas, a neon gas, a krypton gas, a xenon gas, and a helium gas.

11. A method for preventing deterioration of a mobile phase of liquid chromatography, comprising: bubbling the mobile phase of liquid chromatography containing a basic ion-pair reagent.

12. A method for preventing deterioration of a mobile phase, comprising: preparing a mobile phase in which a basic ion-pair reagent is dissolved in a nonaqueous solvent, mixing the mobile phase with a mobile phase containing water, and using the mixture for liquid chromatography.

13. An analytical apparatus, comprising:
a liquid chromatography apparatus separating a sample containing an ionic analyte by using a mobile phase including a basic ion-pair reagent;
a mass spectrometer for analyzing the analyte; and
a deterioration prevention apparatus of the mobile phase.

14. The analytical apparatus according to claim 13, wherein the deterioration prevention apparatus of the mobile phase is a gas bubbling apparatus of the mobile phase.

15. The analytical apparatus according to claim 14, wherein the deterioration prevention apparatus of the mobile phase further comprises a means and a software for managing and controlling bubbling of the mobile phase.

16. The analytical apparatus according to claim 13, wherein the deterioration prevention apparatus of the mobile phase is an apparatus for mixing a mobile phase containing a basic ion-pair reagent in a nonaqueous solvent with a mobile phase containing water.
